(19) United States
(12) Patent Application Publication
(10) Pub. No.: US 2025/0149322 A1
(43) Pub. Date: May 8, 2025

(54) SKIMMERS FOR PLASMA INTERFACES

(71) Applicant: Thermo Fisher Scientific (Bremen) GmbH, Bremen (DE)

(72) Inventor: Joachim HINRICHS, Bremen (DE)

(73) Assignee: Thermo Fisher Scientific (Bremen) GmbH, Bremen (DE)

(21) Appl. No.: 18/722,514

(22) PCT Filed: Dec. 16, 2022
(86) PCT No.: PCT/EP2022/086363

§ 371 Date: Jun. 20, 2024

(30) Foreign Application Priority Data
Dec. 21, 2021 (GB) 2118619.2

(51) Int. Cl. H01J 49/06; H01J 49/10

(52) U.S. Cl. CPC H01J 49/067; H01J 49/105

(57) ABSTRACT

A skimmer cone for a mass spectrometer, such as an ICP mass spectrometer, comprises a base section and a cone section protruding from the base section. The cone section has a substantially conical interior and a substantially conical exterior. The cone section is provided with a top area in which an orifice is provided. The skimmer cone is substantially entirely made of silicon.

### FIELD

The invention relates to skimmers for plasma interfaces. More in particular, the invention relates to skimmers for plasma interfaces in analytical instruments, such as mass spectrometers. Typical plasma interfaces in mass spectrometers are atmosphere-to-vacuum interfaces.

### BACKGROUND

So-called skimmers or skimmer cones are used in plasma interfaces, for example in mass spectrometers. A portion of a plasma into which an analyte may be introduced passes through a first interface part, a sampler or sampling cone, and a second interface part, a skimmer or skimmer cone.

Each of the interface parts has a small opening allowing a portion of the plasma to pass through while maintaining a pressure difference between the exterior and the interior of the plasma interface. In typical applications, the plasma is at atmospheric pressure while the analytical instrument operates at very low pressures.

U.S. Pat. No. 9,012,839 (Thermo Fisher), which is hereby incorporated by reference in this document, discloses a mass spectrometer vacuum interface comprising a skimmer. An expanding plasma is skimmed through the skimmer aperture. To reduce so-called memory effects caused by deposits, the skimmer is shaped so as to separate a portion of the skimmed plasma.

U.S. Pat. No. 10,998,180 (Thermo Fisher), which is hereby incorporated by reference in this document, discloses a plasma sampling interface for an inductively coupled plasma (ICP) mass spectrometer. The plasma sampling interface comprises a conical sampling cone and a conical skimmer cone.

Skimmer cones are typically made of metal, for example nickel, aluminium or platinum. This has the disadvantage that elemental background signals are often elevated due to contamination of the metal surface or of the metal material itself. In addition, deposits easily form on a skimmer cone. When deposits detach during a measurement, they can disturb the measurement results, resulting in inaccurate or incorrect measurement results. It has been proposed to provide a coating on a skimmer to solve these problems. It has been found, however, that suitable coatings may be difficult to apply. In addition, coatings may after some time detach from the skimmer due to the high temperatures of the plasma.

### SUMMARY

Accordingly, the present invention provides a skimmer cone for a mass spectrometer, comprising a base section and a cone section protruding from the base section, the cone section having a substantially conical interior and a substantially conical exterior with a top area in which an orifice is provided, wherein the skimmer cone is made of silicon.

By providing a skimmer cone made of silicon, it is possible to significantly reduce or even eliminate the so-called elemental background signal caused by contamination of the skimmer. Skimmers made of silicon can have a very clean surface. It has been found that due to the production process, it is practically impossible to produce a metal skimmer which does not have surface contaminations. It is however possible to produce a silicon skimmer of which the surface contaminations are negligible.

It is noted that EP 1 865 533 A1 (Microsaic Systems) discloses a micro-engineered vacuum interface for an ionization system in which silicon layers are used. The micro-engineered system is fabricated by lithography, etching and bonding and has dimensions in the order of microns. This known vacuum interface is unsuitable for macroscopic applications, such as inductively coupled plasma (ICP) sources for mass spectrometers.

Although the skimmer cone may have two or more orifices, it is preferred that is has a single orifice. Such a design provides a simple yet effective structure. The single orifice is preferably centrally located in the skimmer cone.

Embodiments of the skimmer cone according to the present invention are substantially entirely made of silicon and may be devoid of any coating or layer. The silicon may be high purity silicon. Although silicon of a lesser purity could be used, for example between 90% and 95%, the reduction or elimination of contaminations is greater at higher purities of over 95%, in particular over 99%. Embodiments of the skimmer may therefore have at least 95% purity, at least 99% purity or at least 99.9% purity, preferably at least 99.99% purity, more preferably at least 99.999% purity, still more preferably at least 99.9999% purity. Thus, the skimmer cone of this invention can be said to substantially consist of silicon only.

The top area may be substantially flat, resulting in a frustoconical shape of the skimmer. A frustoconical shape further reduces the amount of contaminants in the skimmed plasma. In addition, a silicon cone having a frustoconical shape is easier to manufacture. Although the dimensions of the top area may depend on the overall dimensions of the skimmer, it is preferred that the top has a substantially flat area with a width or diameter of at least 1 mm, preferably at least 2 mm. This results in an effective frustoconical shape. The substantially flat top area may have a diameter of less than 7 mm, for example less than 5 mm.

The substantially flat top area may define a shoulder at the interior of the cone section. That is, when the diameter of the orifice is smaller than the diameter of the counterpart of the top area in the interior of the cone section, a shoulder results. The shoulder may have a width or diameter between 0.1 mm and 3 mm, preferably between 0.2 mm and 1.5 mm, more preferably between 0.3 mm and 0.5 mm.

The orifice may have a diameter of between 0.5 mm and 2.0 mm, preferably between 0.6 mm and 1.2 mm, more preferably between 0.7 mm and 1.0 mm. The orifice may be centrally located in the top area.

The skimmer cone may have a diameter of between 10 mm and 50 mm, preferably between 20 mm and 25 mm, more preferably between 21 mm and 22 mm.

The cone section may define an angle between 30° and 80°, preferably between 45° and 70°, more preferably approximately 60°, although other cone angles may also be used. In some embodiments, the skimmer may not have a conical part. Instead, the skimmer may be substantially flat or have a stepped design.

The skimmer cone of the invention may be produced by machining, in particular milling. This allows a smooth and uncontaminated surface of the skimmer to be achieved. This is due to the fact that the selected materials, such as silicon, can be relatively brittle compared to metal, thus giving less rise to contaminations on their surfaces.

The invention also provides a plasma interface comprising a skimmer cone as described above. The plasma interface may additionally comprise a sampler and an interface chamber.

The invention further provides a mass spectrometer comprising a skimmer cone as described above. The mass spectrometer of the invention may further comprise a plasma source, such as an ICP (Inductively Coupled Plasma) source. The mass spectrometer of the invention may additionally comprise a mass filter, such as a multipole mass filter and/or a magnetic sector mass filter and a detector unit.

### BRIEF DESCRIPTION OF THE DRAWINGS

FIG. 1 schematically shows a plasma interface according to the prior art.

FIG. 2A schematically shows a top view of a skimmer cone according to the invention.

FIG. 2B schematically shows a cross-sectional view of a skimmer cone according to the invention.

FIG. 2C schematically shows an enlarged version of the cross-sectional view of FIG. 2B.

FIG. 3 schematically shows a further enlarged part of the cross-sectional view of FIG. 2C.

FIG. 4 shows mass responses for different skimmer cone types.

FIG. 5 shows background concentrations for different skimmer cone types.

### DETAILED DESCRIPTION OF THE DRAWINGS

The invention provides a skimmer cone for a mass spectrometer. The skimmer cone may comprise a base section and a cone section protruding from the base section. The cone section may have a top area in which an orifice is provided. The skimmer cone can be made of silicon. The skimmer cone may be made of silicon only and other materials may therefore be absent from the skimmer cone. The skimmer cone may be round or oval, but may alternatively have a polygonal circumference, such as a square, rectangular, or hexagonal circumference. The invention also provides a plasma interface and a spectrometer comprising a skimmer cone.

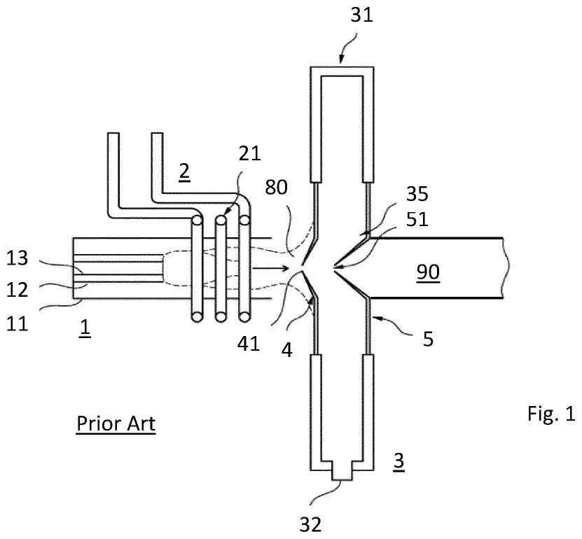

FIG. 1 shows a plasma interface as disclosed in the above-mentioned U.S. Pat. No. 10,998,180, the entire contents of which are hereby incorporated by reference in this document. The plasma interface 3 is shown together with a plasma torch 1, which is provided with an RF coil 2 to form an ICP (Inductively Coupled Plasma) source.

The plasma torch 1 is shown to consist of three concentrical tubes 11, 12 and 13, which tubes are typically made from quartz. A gas which is to form the plasma, typically argon, is passed between the outer and middle tubes 11 and 12, with an auxiliary gas being supplied between the middle tube 12 and a sample tube 13. A sample to be analyzed can be provided in a carrier gas through the innermost sample tube 13.

The plasma torch 1 is placed centrally in an RF coil 2, about 1-2 cm from the interface 3. In the embodiment shown, the RF coil 2 has three windings 21. A radio frequency (RF) generator (not shown) provides RF power (typically 500 to 1500 W) to the RF coil 2. The RF coil 2 causes an intense electromagnetic field to be generated near an end of the torch. As argon gas (or another suitable gas) flows through the torch, a high-voltage spark is applied to the gas, which causes stripping of electrons from argon atoms. These released electrons collide with other argon atoms in the gas, stripping the argon atoms of more electrons. The result is a chain reaction of events that breaks down the argon atoms into argon ions and electrons, thus creating a plasma. This process is maintained by the continuing transfer of RF energy to the torch 1.

Sample gas delivered through the innermost tube 13 is delivered into the plasma 80 which may have a temperature in the range of 5000 to 10,000 K. The result is a series of chemical changes, starting with desolvation of the sample (typically provided as an aerosol), followed by gas formation and formation of charged ions through the collision of high-energy electrons and argon ions with ground-state atomic species. The arrow indicates the flow of plasma gas that is generated in the ICP source towards the plasma interface 3.

The interface 3 consists of a housing 31 that has an internal chamber 35 which is pumped by a vacuum pump (not shown) via a gas orifice 32. Ions from the plasma enter the chamber 35 via a sampler 4, which is typically a conical structure having a small aperture or orifice 41 with an internal diameter that is typically in the range of 0.8 to 1.2 mm. Some of the sampled ions in the chamber 35 can pass through a skimmer 5 which may also comprise a conical structure and has an aperture or orifice 51 with a diameter that is typically about 0.4 to 0.8 mm. As skimmers often have this conical structure, they are typically referred to as skimmer cones.

Downstream of the interface 3, an ion guide 90 may be provided to guide ions that passed through the interface. The ions may be guided towards a mass analyser (not shown), where the mass to charge ratio of the ions may be determined, for example.

Skimmers or skimmer cones according to the prior art are made of metal, for example copper, nickel, aluminium or platinum, or combinations of these or similar metals. Although metal may be suitable to withstand the high temperatures involved, it has the disadvantage of causing elevated elemental background signals, and additionally, that deposits can easily form on the metal surface.

Although deposits on the skimmer surface may not present a problem as such, these deposits may come loose or become re-ionized and then influence the measurement results.

In addition, the metal surface may be relatively rough due to wear during use and after cleaning, making it more likely for deposits to attach to a metal skimmer cone. According, the present invention provides a skimmer or skimmer cone on which deposits are less likely to form.

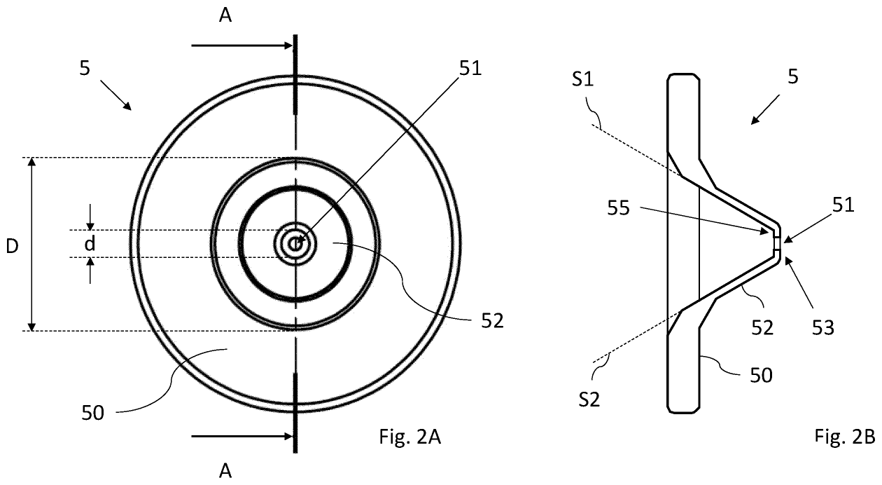

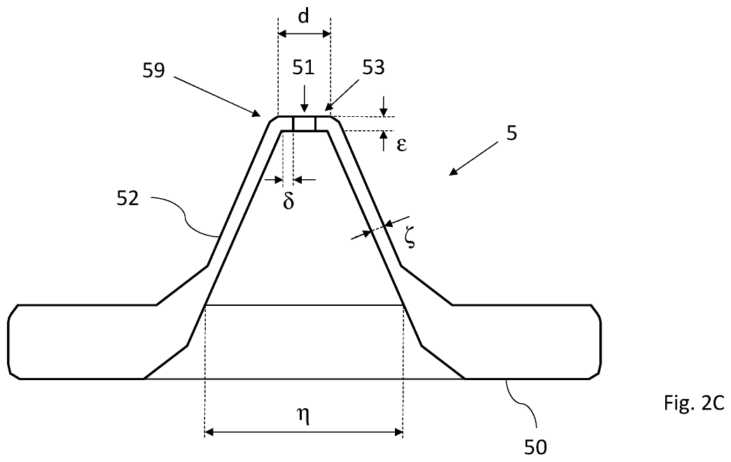

An embodiment of a skimmer according to the invention is shown in FIGS. 2A, 2B and 2C, where FIG. 2A shows a top view and FIG. 2B shows a cross-sectional view along the line A-A. FIG. 2C shows an enlarged version of the cross-sectional view along the line A-A.

The skimmer 5 of FIGS. 2A and 2B has a substantially round and flat base 50 from which a conical section 52 protrudes. The conical section 52 has a substantially flat top area 53, in which an aperture or orifice 51 is arranged. The conical section 52 is hollow and has, in the embodiment shown, a smaller wall thickness than the base 50. The conical section 52 has, in the embodiment shown, an inside angle (between the lines S1 and S2 in FIG. 2B) of approximately 60°. As can be seen in FIG. 2B, the skimmer 5 shown has no sharp corners, as all corners have angles of at least 45°. In some embodiments, these corners can be curved instead of having obtuse angles. In the embodiment shown, only the orifice 51 has angles of approximately 90°, due to the orifice 51 being produced by drilling. In other embodiments, however, at least some of the angles of the edges of the orifice 51 may also be obtuse.

The relatively flat top area 53 at the outside of the skimmer corresponds with a flat area on the inside, resulting in a shoulder 55 in the interior of the cone. The resulting frustoconical shape further reduces the amount of contaminations in the skimmed plasma, as contaminations well tend to accumulate at the shoulder 55. The top area 53 has a diameter d (see also FIG. 2C) of at least 1 mm, preferably at least 2 mm, and typically not more than for example 5 mm, although wider top areas 53 are also possible, for example having a diameter d of 7 mm or 8 mm, depending on the other dimensions of the skimmer.

As mentioned above, the skimmer 5 may be made entirely of silicon. The silicon may be high purity silicon, for example at least 95% purity, at least 99% purity or at least 99.99% purity or even at least 99.9999% purity.

Although the base section 50 and the conical section 52 may be constituted by separate parts which are joined after being produced separately, in the embodiment of FIGS. 2A and 2B the conical section 52 is integral with the base section 50. The skimmer cone 5 may thus consist of a single solid part of silicon.

A skimmer cone according to the present invention may have a diameter of between 10 mm and 50 mm, preferably between 20 mm and 25 mm, for example 21 mm or 22 mm. The substantially flat top area may have a diameter d of, for example, between 1 mm and 4 mm. The cone section or cone part 52 may define an (inner) angle between 30° and 80°, or between 45° and 70°, for example 60°. The cone section 52 has a largest diameter D at the base section 50. The largest diameter D may, for example, be between 5 mm and 30 mm, also depending on the other dimensions of the skimmer 5. A particularly suitable largest diameter D is between 8 mm and 25 mm, in particular between 10 mm and 15 mm, for example approximately 12 mm.

Embodiments can be envisaged in which the middle section of the skimmer is not conical but may have a substantially stepped cross-section or may be flush with the base 50.

The aperture or orifice 51 may have a diameter between approximately 0.4 mm and 2 mm, preferably approximately 1 mm. The cone part may have a largest overall diameter between 2 mm and 20 mm, preferably between 5 mm and 15 mm, for example approximately 10 mm or 12 mm.

The cross-sectional view of FIG. 2B is shown in more detail in FIG. 2C. The cone section 52 can be seen to extend from the base section 50. The orifice 51 is arranged in a relatively flat top area 53 having a top area width or diameter d. The transition at 59 from the cone section 52 to the top area 53 is shown to have obtuse angles due to the beveled edges. In this way, sharp edges which could be relatively easily damaged are avoided.

The relatively flat top area 53 at the exterior of the skimmer corresponds with a flat area on the inside, resulting at the interior in a shoulder (55 in FIG. 2B) having a width S. As mentioned above, the shoulder width S is preferably between 0.1 mm and 3 mm. It will be understood that the shoulder width S may depend on the other dimensions of the skimmer cone 5, including the cone angle. Thus, the shoulder width S may be between 0.2 mm and 1.5 mm, in some embodiments between 0.3 mm and 0.5 mm.

The wall of the conical section 52 has, at the top section 53, a thickness E which may be in a range from 0.1 mm to 0.5 mm, for example approximately 0.3 mm. Accordingly, the length of the orifice 51 is, in the embodiment shown, also equal to E. The wall of the conical section 52 has, at the sides, a thickness (which may also be in a range from 0.1 mm to 2 mm, for example approximately 0.5 mm. At the top surface of the base 50 (that is, the surface from which the conical section 52 protrudes), the conical section has an inner diameter 1l. This inner diameter 1l may be in a range from 5 mm to 12 mm, and may for example be equal to approximately 9 mm. It will be understood that the dimensions of the skimmer cone may be chosen in dependence on the particular application, such as on the dimensions of the mass spectrometer interface in which the skimmer cone is used.

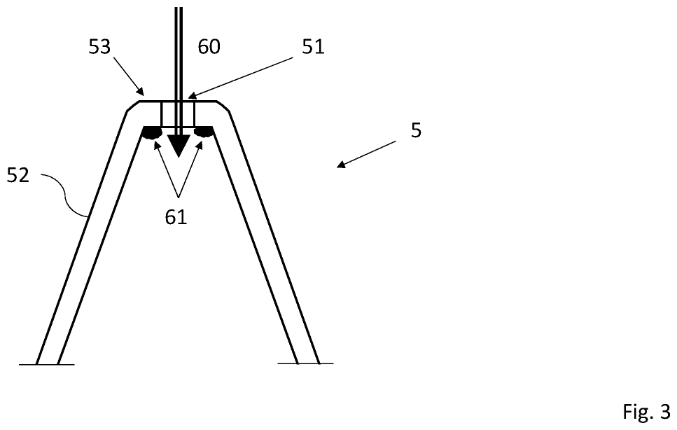

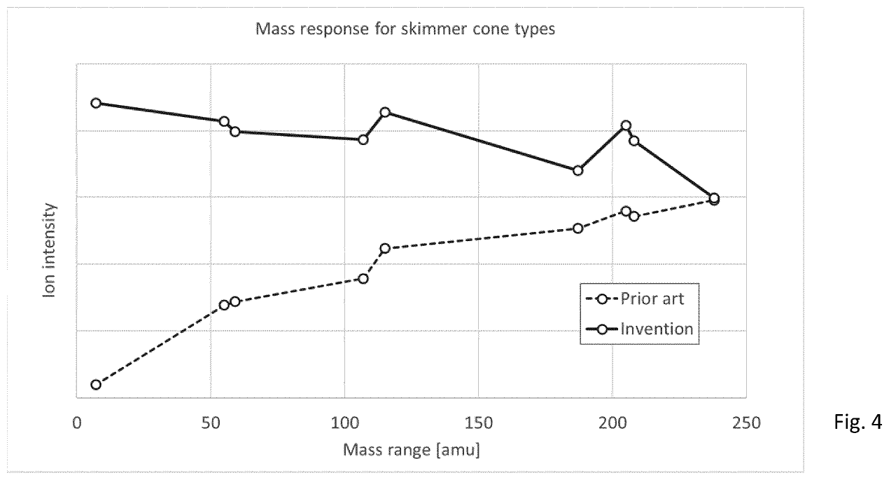

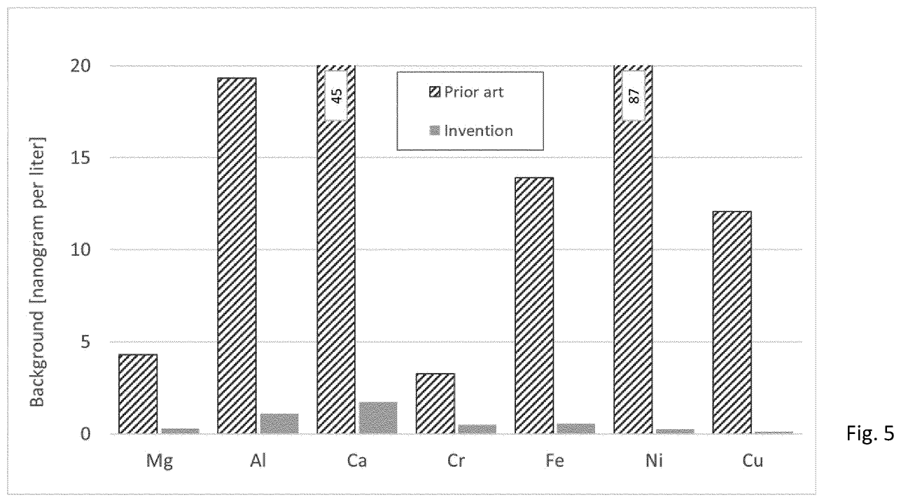

The part of the skimmer 5 schematically shown in FIG. 3 also comprises a cone section 52 having a relatively flat top area 53, in which an orifice 51 is provided. As shown in FIG. 3, in use plasma 60 passes through the orifice 51. Due to the frustoconical shape of the skimmer 5, any deposits 61 will form mainly in the interior of the skimmer, on the shoulder (55 in FIG. 2B) to the side of the orifice 51. At this location, it is very unlikely that deposits will be re-ionized. In addition, the geometry of the skimmer is not altered. As a result, the ion transmission through the skimmer into the mass spectrometer will remain substantially constant. This effect is schematically shown in FIGS. 4 and 5.

In the graph of FIG. 4, the mass response for different types of skimmer cones is illustrated. The lower, interrupted line represents the ion intensity as a function of mass as measured by a mass spectrometer using a skimmer according to the prior art. The upper, solid line represents the ion intensity as a function of mass as measured by a mass spectrometer using a skimmer according to the invention. As can be seen, the skimmer according to the prior art, which is typically pointed, produces an ion intensity which is strongly mass-dependent. In particular low masses result in a low ion intensity. In contrast, the skimmer according to embodiments of the invention produces an ion intensity which is far less mass-dependent and in particular for lower masses results in a significantly higher measured ion intensity. This is due to the frustoconical shape of the skimmer. Accordingly, according to a further aspect, the invention provides a skimmer cone having a frustoconical shape.

The absence of contamination which can be achieved with a skimmer made of silicon greatly reduces the background signal, while the frustoconical shape strongly reduces the influence of deposits on the skimmer and thus reduces the background signal even further.

It is noted that part of the advantages illustrated in FIG. 4 may be achieved with a frustoconical skimmer made of another material, for example a metal such as copper or nickel. However, the advantage of the highly reduced surface contamination may only be obtained with a skimmer made of silicon or an equivalent material.

In FIG. 5, the background signal (measured ion intensity in a pure water sample) in nanogram per liter of sample (typically pure water) is illustrated for skimmers according to the prior art (dashed) and skimmers according to the invention (solid) for various elements. It is clear that the background signal measured with skimmers according to the invention is significantly lower than for skimmers according to the prior art.

Advantages of the use of silicon or equivalent materials to produce a skimmer cone comprise:
a) The use of high purity material for cone manufacturing of preferably 99.9999% (“6N purity”, and higher) purity silicon avoids input from impurities of the cone material itself to a very large extent. Metallic base materials are commonly limited to 5N (99.999%) purity.
b) The use of grinding techniques for these non-metallic materials provides cleaner surfaces, since the materials are brittle and generate little subsurface machining contaminations. Machined metallic cones are subject to subsurface contaminations from machining tools, procedures, process liquids, and from electroplating chemicals.
c) Silicon (Si) materials can be cleaned in strong and concentrated acids for surface contamination removal, due to their chemical resistivity to most mineral acids (other than hydrofluoric acid (HF)). In contrast, only strongly diluted solutions can be used for metallic cones as otherwise the material itself would be affected and especially the geometry of the cone tip would deteriorate. This type of cleaning is generally insufficient to dissolve surface contaminations. Silicon skimmers enable better surface cleaning for a lower BEC (Background Equivalent Concentration).
d) Silicon materials can be cleaned in strong and concentrated acids enabling or facilitating removal of previously deposited sample material from matrix solutions.
e) A longer lifetime due to the hardness of silicon: based on the materials itself, and the shape for machining, the edges of the central channel of the cone orifice are more robust to erosion from the ion beam and chemical erosion. This extends the cone lifetime and improves the reproducibility of the tip geometry, leading to stable tune conditions over time.
f) Silicon materials can be cleaned by polishing techniques: sample deposits can be removed, and the surface can be cleaned, by polishing, without modification of the tip characteristics. Metallic cones are generally not polished at the tip, occasionally just at the inside or in the vicinity of the tip outside, to avoid damage to the relatively sharp and fragile tip geometry, which can cause a loss of performance.

Although the description above focuses on silicon as material from which the skimmer can be made, it has been found that other materials may also be suitable for producing skimmers, such as skimmer cones. The following materials may alternatively, or additionally, be used:
boron carbide (B₄C),
boron nitride (BN),
aluminium oxide (Al₂O₃),
aluminium nitride (AlN),
silicon carbide (SiC), and/or
silicon oxide (SiO₂).

The invention also provides a plasma interface comprising a skimmer consisting of silicon. The plasma interface may be an ICP interface.

The invention additionally provides a spectrometer, such as a mass spectrometer, comprising a skimmer consisting of silicon. The spectrometer may be an ICP mass spectrometer.

It will be understood by those skilled in the art that the invention is not limited to the embodiments shown and that many additions and modification may be made without departing from the scope of the invention as defined in the appending claims.

1. A skimmer cone for a mass spectrometer, comprising a base section and a cone section protruding from the base section, the cone section having a substantially conical interior and a substantially conical exterior with a top area in which an orifice is provided, wherein the skimmer cone is made of silicon.

2. The skimmer cone according to claim 1, wherein the silicon has at least 99.9% purity.

3. The skimmer cone according to claim 1, wherein the top area is substantially flat.

4. The skimmer cone according to claim 3, wherein the substantially flat top area has a diameter of at least 1 mm.

5. The skimmer cone according to claim 3, wherein the substantially flat top area defines a shoulder at the interior of the cone section.

6. The skimmer cone according to claim 5, wherein the shoulder has a width between 0.1 mm and 3 mm.

7. The skimmer cone according to claim 1, wherein the orifice has a diameter of between 0.5 mm and 2.0 mm.

8. The skimmer cone according to claim 1 has a diameter of between 10 mm and 50 mm.

9. The skimmer cone according to claim 1, wherein the cone section defines an angle between 30° and 80°.

10. The skimmer cone according to claim 1 is produced by machining.

11. The skimmer cone according to claim 1 which is produced by machining followed by grinding.

12. The skimmer cone according to claim 1, wherein the orifice is provided by drilling.

13. A plasma interface comprising a skimmer cone according to claim 1.

14. The plasma interface according to claim 13, further comprising a sampling cone.

15. A mass spectrometer comprising a skimmer cone according to claim 1.

16. The mass spectrometer according to claim 15, further comprising an inductively coupled plasma source.

17. The skimmer cone according to claim 2, wherein the silicon has at least 99.9999% purity.

18. The skimmer cone according to claim 4, wherein the substantially flat top area has a diameter of at least 2 mm.

19. The skimmer cone according to claim 6, wherein the shoulder has a width between 0.3 mm and 0.5 mm.

20. The skimmer cone according to claim 7, wherein the orifice has a diameter of between 0.7 mm and 1.0 mm.
